(19) United States
(12) Patent Application Publication
(10) Pub. No.: US 2010/0315314 A1
(43) Pub. Date: Dec. 16, 2010

(54) SYSTEMS, METHODS AND DEVICES FOR IMPROVED IMAGING

(75) Inventors: Daniel van der Weide, Verona, WI (US); John Grade, Waunakee, WI (US)

Correspondence Address: Casimir Jones, S.C., 2275 DEMING WAY, SUITE 310, MIDDLETON, WI, 53562, US

(73) Assignee: TERA-X, LLC, Verona, WI (US)

(21) Appl. No.: 12/848,421

(22) Filed: Aug. 2, 2010

Related U.S. Application Data
(63) Continuation of application No. 12/116,666, filed on May 7, 2008, now Pat. No. 7,768,458.
(60) Provisional application No. 60/928,003, filed on May 7, 2007.

(51) Int. Cl. H01Q 21/24

(52) U.S. Cl. 343/893

(57) ABSTRACT

The present invention provides devices, systems and methods for imaging and transmitting images. In particular, the present invention provides, systems, methods and devices for free-space polarization modulation.

### CROSS-REFERENCE TO RELATED APPLICATION

The present invention is a continuation of allowed U.S. patent application Ser. No. 12/116,666, filed Aug. May 7, 2008, which will issue on Aug. 3, 2010 as U.S. Pat. No. 7,768,458, which claims priority to pending U.S. Provisional Application No. 60/928,003, filed May 7, 2007, entitled “Systems, Methods and Devices for Improved Imaging,” both of which are herein incorporated by reference their entireties.

### BACKGROUND

Improved antennas and related methods of imaging are needed.

### SUMMARY

The present invention provides devices, systems and methods for imaging and transmitting images. In particular, the present invention provides, systems, methods and devices for free-space polarization modulation.

### BRIEF DESCRIPTION OF THE DRAWINGS

FIG. 1 shows an embodiment of the present invention. FIG. 1A shows differentially driven antennas AD & BC, oriented at +/−45 degrees to x- and y-axis. As shown, simultaneous pulses create a virtual x-axis antenna along the dashed lines with +41% amplitude. FIG. 1B shows differentially driven antennas AD & BC, oriented at +/−45 degrees to x- and y-axis. As shown, alternating pulses create a virtual y-axis antenna along the dashed lines with +41% amplitude.

FIG. 2 shows an embodiment of the present invention. In particular, FIG. 2 shows that a delay change at input creates polarization change in free space which shows up as, for example, amplitude modulation at detector.

### DETAILED DESCRIPTION

The present invention provides devices, systems and methods for imaging and transmitting images. In particular, the present invention provides, systems, methods and devices for free-space polarization modulation.

In some embodiments, the present invention provides systems and devices employing a plurality of antennas. The present invention is not limited to a particular type and/or kind of antennas. In some embodiments, the antennas are used for achieving enhanced imaging (e.g., better resolution and magnification).

In some embodiments, the invention provides a combination of two antennas (e.g., identical antennas). The present invention is not limited to a type of antenna. The present invention is not limited to a particular manner of combining the antennas. In some embodiments, the antennas are combined such that two identical antennas are arranged with the antennas radiating in the z direction with E-fields oriented at +/−45 degrees from the x-axis. In some embodiments, the antennas are oriented at 0 and 90 degrees such that a phase change to the physical antennas causes the antennas to be turned on or off, thereby allowing modification of individual pulses. In such embodiments, the combined antennas generate a far field radiation pattern that is equivalent to a single antenna with increased power (e.g., increased by 41%) oriented along either the x-axis (e.g., when the input waveforms are in phase) or the y-axis (e.g., when the input waveforms are 180 degrees out of phase).

In some embodiments, the phase in the physical antennas is adjusted to rotate the polarization of the synthesized antennas (at a single frequency) so as to allow a single antenna pair to interrogate a target over an entire polarization range. In some embodiments, depth ambiguity is accomplished through coded modulation of pulses, or groups of pulses. In some embodiments, depth of focus is determined via code length. In some embodiments, depth of field is determined through time shift between send and return correlation.

In some embodiments, when the input waveform is a step or pulse, a relative delay between the input waveforms is created such that the pulses or steps are either simultaneous or alternating, thus creating broadband radiation pulses that are aligned with the x- or y-axis, respectively. In some embodiments, the relative delay is accomplished by changing the relative phase of the input waveforms to a pair of nonlinear transmission lines.

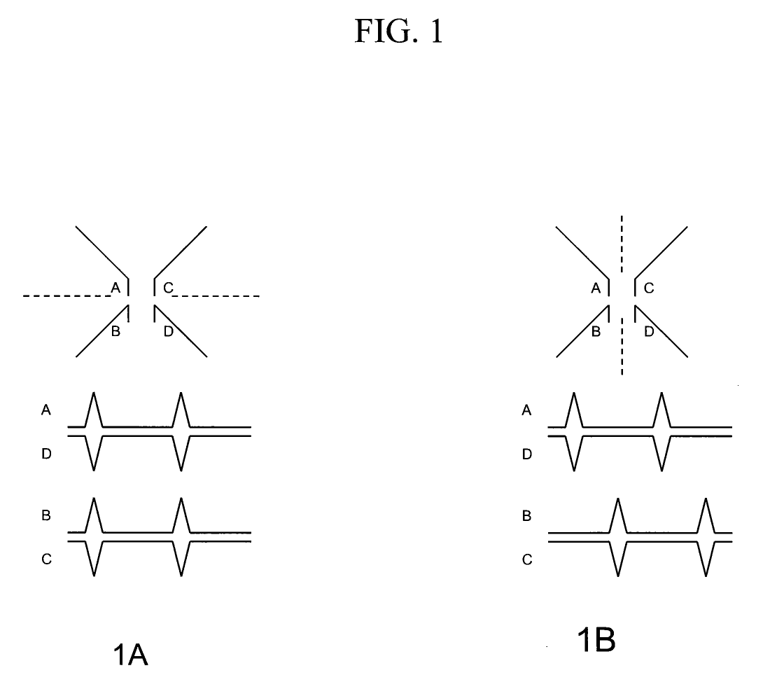

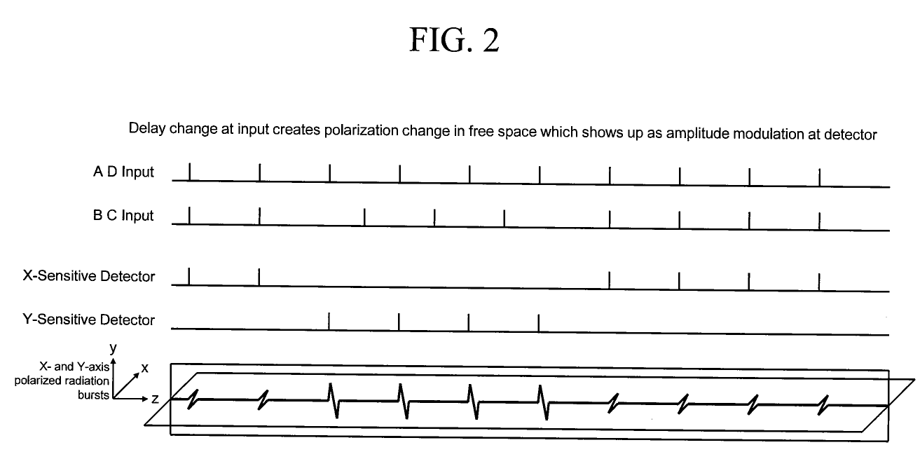

FIGS. 1 and 2 show different embodiments of the present invention. The present invention is not limited to these embodiments.

In some embodiments, the present invention provides devices comprising one or more detectors that are sensitive to radiation polarized along an x-axis and/or y-axis. The present invention is not limited to a particular type or kind of detector. In some embodiments, the detector is configured to receive pulses created by simultaneous waveforms (e.g., along the x-axis). In some embodiments, the detector is configured to receive pulses created by alternating waveforms (e.g., along the y-axis). In some embodiments, the detectors of the present invention, through use of, for example, free-space polarization modulation, enable modulation of the detected amplitude of individual pulses (or groups of pulses) even though the generated pulses are all at constant amplitude.

In some embodiments, the present invention provides systems and methods for polarization coding. The present invention is not limited to particular systems or methods for polarization coding. In some embodiments, free-space polarization modulation is used to transmit information via a modulated signal (e.g., with a synthesized antenna described above). In some embodiments, such polarization modulation is only detectable using suitably polarized detectors of the present invention, and appearing as un-coded constant-amplitude pulses on any non-polarized detectors.

In some embodiments, the present invention provides systems and methods for transmitting coded information. The present invention is not limited to particular systems or methods for transmitting coded information. In some embodiments, free-space polarization modulation is used to transmit coded information such as, for example, a pseudo-random bitstream (PRBS) in order to filter out unwanted signals. In some embodiments, a filter (e.g., a PRBS filter) is used for time-gating in, for example, stand-off detection applications. In some embodiments, the time-gating reduces the impact of spurious signals from objects closer to or farther away from the target of interest and reducing the effect of multiple reflections.

1. A device comprising two identical or substantially identical antennas, wherein said antennas are oriented such that each is radiating in the z direction with E-fields oriented at +/−45 degrees from the x-axis.

2. The device of claim 1, wherein said antennas provide a far field radiation pattern equivalent to a single antenna with increased power oriented along either the x-axis or the y-axis.

3. A method of generating broadband radiation pulses aligned with an x or y axis, comprising providing a device of claim 1, and creating a relative delay between input waveforms.

4. A system comprising the device of claim 1 and a device comprising one or more detectors configured to detect pulses created by the device of claim 1.
